(19) United States
(12) Patent Application Publication
(10) Pub. No.: US 2024/0220824 A1
(43) Pub. Date: Jul. 4, 2024

(54) CONDITION BASED ASSET MANAGEMENT

(71) Applicant: Exelon Corporation, Chicago, IL (US)

(72) Inventors: Cara Gilad, Chicago, IL (US); Jeff Swiatek, Chicago, IL (US); Amin Tayyebi, Chicago, IL (US); Ankush Agarwal, Chicago, IL (US); George Leinhauser, Chicago, IL (US); Po-Chen Chen, Chicago, IL (US)

(21) Appl. No.: 18/149,725

(22) Filed: Jan. 4, 2023

(51) Int. Cl. G06N 5/022

(52) U.S. Cl. CPC G06N 5/022

(57) ABSTRACT

Methods, systems, and apparatuses for predicting a measure of success of a maintenance cycle performed on an asset based on a plurality of operational parameters. A predictive model may be trained and tested based on the plurality of operational parameters. The predictive model may be configured to output a prediction indicative of the measure of success of the maintenance cycle.

### BACKGROUND

A power system comprises a network of electrical components or power system equipment configured to supply, transmit, and/or use electrical power. For example, a power grid (e.g., also referred to as an electrical distribution grid) comprises generators, transmission systems, and/or distribution systems. Generators, or power stations, are configured to produce electricity from combustible fuels (e.g., coal, natural gas, etc.) and/or non-combustible fuels (e.g., such as wind, solar, nuclear, etc.). Transmission systems are configured to carry or transmit the electricity from the generators to loads. Distribution systems are configured to feed the supplied electricity to nearby homes, commercial businesses, and/or other establishments. Among other electrical components, such power systems may comprise one or more transformers configured to convert or transform electricity at one voltage (e.g. a voltage used to transmit electricity) to electricity at another voltage (e.g., a voltage desired by a load receiving the electricity). Depending upon the scale of the power system and/or the load applied to the transformer, the cost to purchase transformers can range from a few thousand dollars to over one million dollars.

Thus, utility companies can greatly benefit from the use of machine learning methods and models for determining a measure of success associated with a maintenance cycle, especially in relation to transformers. However, one of the biggest issues facing the use of machine learning is the lack of availability of large, annotated datasets. The annotation of data is not only expensive and time consuming but also highly dependent on the availability of expert observers. The limited amount of training data can inhibit the performance of supervised machine learning algorithms which often need very large quantities of data on which to train to avoid overfitting. So far, much effort has been directed at extracting as much information as possible from what data is available. One area in particular that suffers from lack of large, annotated datasets is the analysis of operational data associated with unit transformers. The ability to analyze operational data of a transformer to predict a measure of success of a maintenance cycle is critical to managing the maintenance cycles of these transformers. However, in many instances, insufficient data are available to train machine learning algorithms to accurately predict the measure of success of a maintenance cycle.

### SUMMARY

It is to be understood that both the following general description and the following detailed description are exemplary and explanatory only and are not restrictive.

In an embodiment, disclosed are methods comprising determining operational data associated with a plurality of operational parameters associated with an asset, wherein the plurality of operational parameters comprise one or more groups of operational parameters, and wherein each group of operational parameters is labeled according to a feature score, determining, based on the operational data, a plurality of feature scores for a predictive model, training, based on a first portion of the operational data, the predictive model according to the plurality of feature scores, testing, based on a second portion of the operational data, the predictive model, and outputting, based on the testing, the predictive model.

In an embodiment, disclosed are methods comprising determining a time series of data associated with the asset, wherein the time series comprises one or more time periods, performing an analysis for each time period of the data of the one or more time periods of the data, and generating, based on the analysis of each time period of the data, the operational data, wherein the operational data comprises a data set associated with each time period.

In an embodiment, disclosed are methods comprising determining, based on the plurality of operational parameters, one or more operational data sets that comprise at least one operational parameter of the plurality of operational parameters, and generating, based on the one or more operational data sets, the operational data.

In an embodiment, disclosed are methods comprising determining baseline feature scores for each group of operational parameters of the plurality of operational parameters, labeling the baseline feature scores for each group of operational parameters of the plurality of operational parameters as the feature score associated with each group of operational parameters, and generating, based on the labeled baseline feature scores, the operational data.

In an embodiment, disclosed are methods comprising receiving operational parameter data associated with a plurality of operational parameters of an asset, wherein the plurality of operational parameters are determined during operation of the asset, providing, to a predictive model, the operational parameter data, and determining, based on the predictive model, a prediction score associated with a maintenance cycle performed on the asset.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of the present description serve to explain the principles of the methods and systems described herein:

FIG. 1 shows a flowchart of an example method;

FIG. 2 shows an example machine learning system;

FIG. 3 shows a flowchart of an example machine learning method;

FIG. 4 shows a block diagram of an example computing device;

FIG. 5 shows a flowchart of an example method; and

FIG. 6 shows a flowchart of an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, the methods and systems may take the form of a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

Methods and systems are described for generating a machine learning classifier for the prediction of a measure of success of a maintenance cycle performed on an asset (e.g., transformer) based on a plurality of operational parameters associated with the asset. Machine learning (ML) is a subfield of computer science that gives computers the ability to learn without being explicitly programmed. Machine learning platforms include, but are not limited to, naïve Bayes classifiers, support vector machines, decision trees, neural networks, and the like. In an example, operational data may be generated based on a plurality of operational parameters of the asset. The plurality of operational parameters may comprise one or more groups of operational parameters. In an example, feature scores may be generated for the one or more groups of operational parameters. As a further example, the feature scores may be analyzed to determine a prediction score indicative of a measure of success of a maintenance cycle performed on an asset. The feature scores may comprise a metric indicative of the measure of success of the maintenance cycle performed on the asset based on the one or more groups of operational parameters.

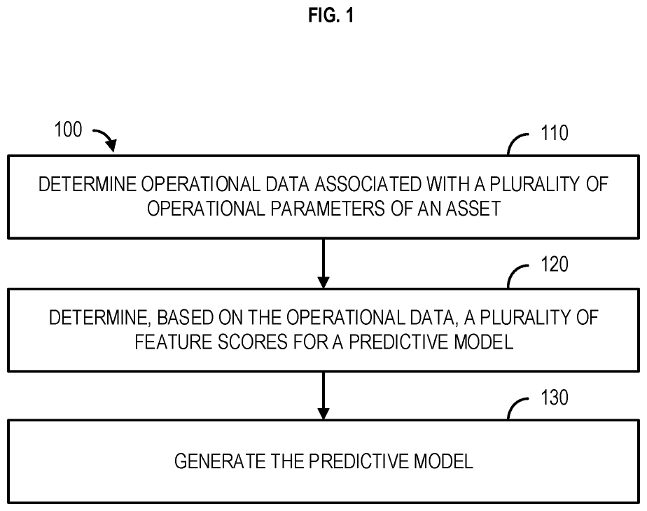

FIG. 1 shows a flowchart of an example method 100 for generating a predictive model comprising determining operational data associated with a plurality of operational parameters of an asset (e.g., transformer) at step 110, determining, based on the operational data, a plurality of feature scores for a predictive model at step 120, and generating, based on the plurality of feature scores, the predictive model at step 130.

The operational data may comprise one or more data sets based on a plurality of operational parameters of an asset. Each data set of the one or more data sets may comprise data indicative of a time series of data associated with the plurality of parameters of the asset. The plurality of operational parameters may comprise one or more of power parameters, voltage parameters, current parameters, capacity parameters, heat parameters, cooling tubes parameters, oil tank parameters, sunlight duration parameters, height of the transformer, date of manufacture, manufacturer data, date of installation, vehicle traffic density, or air temperature parameters. The plurality of operational parameters may comprise one or more groups of operational parameters. Each group of operational parameters of the plurality of operational parameters may be labeled according to a feature score. The feature score may comprise a metric indicative of a measure of success of a maintenance cycle performed on the asset based on the one or more groups of operational parameters. For example, the metric may comprise a value (e.g., 0-10) indicative of a level of success associated with a maintenance cycle performed on the asset. The value may be compared to a threshold (e.g., 1-10) indicating whether the maintenance cycle was successful. For example, if the metric is above the threshold, it may be determined that the maintenance cycle was not successful. If the metric is below the threshold, it may be determined that the maintenance cycle was successful. As an example, the metric may comprise a value of 1 if it was determined that the maintenance cycle was successful or the metric may comprise a value of 0 if it was determined that the maintenance cycle was unsuccessful.

Determining the operational data associated with the plurality of operational parameters at step 110 may comprise downloading/obtaining/receiving one or more operational parameter data sets, obtained from various sources, including recent publications and/or publically available databases. As an example, the operational data may be determined based on determining a time series of data associated with the plurality of operational parameters of the asset, wherein the time series may comprise one or more time periods. An analysis may be performed for each time period of the data, wherein the data may be transformed, based on the analysis of each time period of the data, and provided as input data for determining/generating the predictive model. The operational data may be transformed to address any imbalances in the model data. For example, the operational data may be transformed based on one or more methods such as imputation methods, methods for handling outliers, binning methods, log transformation methods, data aggregation methods, or scaling methods. In an example, the transformed operational data may increase the data resolution by 15 times.

As a further example, the operational data may be transformed, or concatenated, with a numerical representation of a corresponding computational variable(s) and into a single concatenated numerical representation (e.g., a concatenated vector). Concatenated vectors may describe the operational data and the corresponding computational variable(s) as a single numerical vector, fingerprint, representation, etc. The concatenated vectors may be passed to one or more machine learning-based models.

As a further example, the operational data may be determined (e.g., generated) based on one or more operational data sets, wherein the one or more operational data sets may comprise at least one operational parameter of the plurality of operational parameters. As a further example, the operational data may be determined based on baseline feature scores associated with each group of operational parameters. The baseline feature scores may be labeled as the feature score associated with each group of operational parameters. The methods described herein may utilize the one or more operational data sets to improve identification of whether the maintenance cycle of an asset was successful.

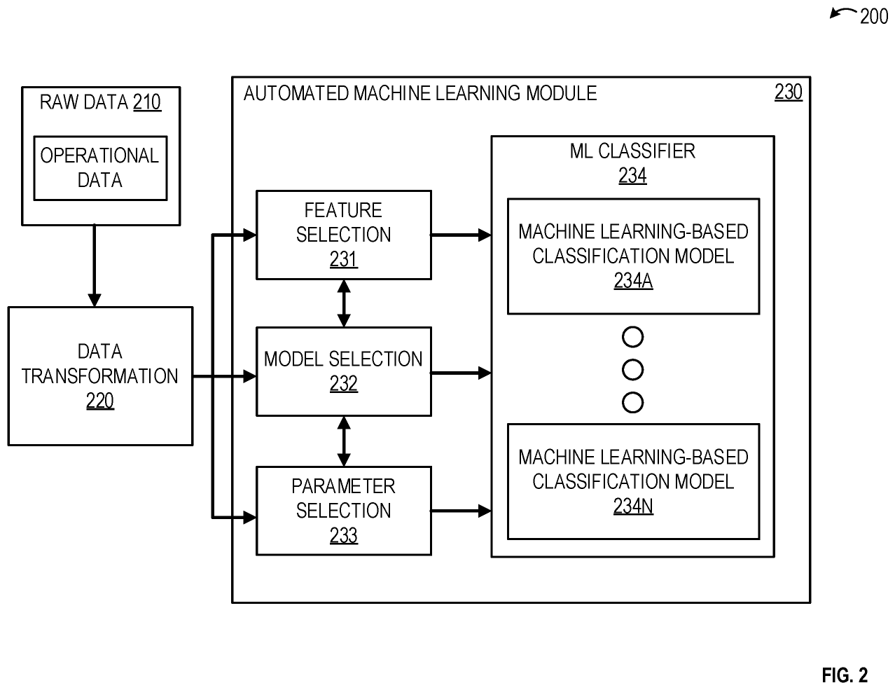

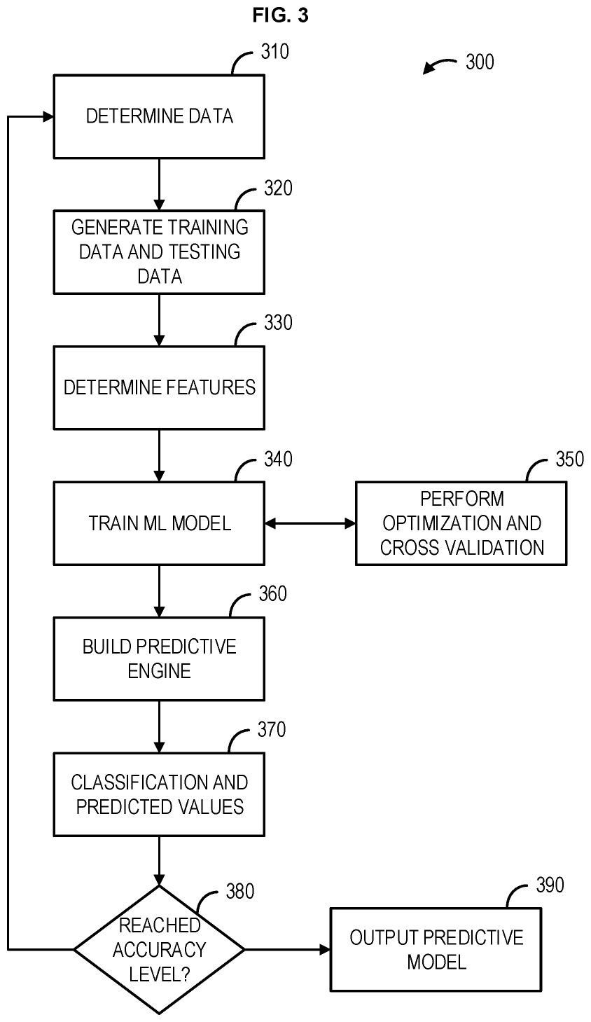

Determining, based on the operational data, a plurality of feature scores for a predictive model at step 120 and generating, based on the plurality of feature scores, the predictive model at step 130 are described with regard to FIG. 2 and FIG. 3.

For example, a predictive model (e.g., a machine learning classifier) may be generated to determine a prediction score indicative of a measure of success of a maintenance cycle performed on an asset (e.g., transformer). The predictive model may be trained according to the operational data (e.g., one or more operational data sets). The operational data sets may contain time series data sets associated with an asset's operational parameters such as power parameters, voltage parameters, current parameters, capacity parameters, heat parameters, cooling tubes parameters, oil tank parameters, sunlight duration parameters, height of the transformer, date of manufacture, manufacturer data, date of installation, vehicle traffic density, or air temperature parameters. The operational data may be associated with baseline feature scores associated with one or more groups of operational parameters, wherein the baseline feature scores may be indicative of a measure of success of a maintenance cycle performed on the asset. The baseline feature scores may relate to studies involving various sources across multiple platforms for a utility such as work order preventative/corrective maintenance, transformer oil dissolved gas analysis (DGA), tap controller oil DGA, inspection data, or equipment nameplate data across different time resolutions. In an example, the baseline feature scores may relate to historical data comprising historical sensor data derived from one or more sensors in communication with the components of the assets and/or historical field test data derived from one or more field tests performed on the components of the assets. In an example, one or more prediction scores of the predictive model may be generated based on the operational data.

The historical data may further relate to merely a subset of the components of the assets (e.g., transformers). For example, the historical data may pertain to a particular class or type of transformer (e.g., configured to convert voltage between a first voltage or first voltage range and a second voltage or second voltage range).

FIG. 2 shows an example system 200 that is configured to use machine learning techniques to train, based on an analysis of one or more transformed/preprocessed training data sets 210/220 by a machine learning module 230, and at least one machine learning-based classifier 234 that is configured to classify baseline feature data as being associated with a feature score, or metric, associated with a measure of success of a maintenance cycle performed on an asset (e.g., transformer). For example, the machine learning module 230 may comprise an automated machine learning module 230. The automated machine learning module 230 may automatically perform feature selection 231, model selection 232, and parameter selection 233 without human interaction. The training data set 210 may comprise operational data, wherein the operational data may comprise one or more operational data sets and/or labeled baseline feature scores associated with one or more groups of operational parameters. The one or more operational data sets may comprise one or more time series data sets associated with the one or more groups of operational parameters. The one or more operational data sets 210 may be transformed 220 based on one or more methods in order to address any imbalances in the model/training data. For example, the operational data may be transformed using methods such as imputation methods, methods for handling outliers, binning methods, log transformation methods, data aggregation methods, or scaling methods. The transformed operational data may increase the data resolution by 15 times. The operational parameters may comprise one or more of power parameters, voltage parameters, current parameters, capacity parameters, heat parameters, cooling tubes parameters, oil tank parameters, sunlight duration parameters, height of the transformer, date of manufacture, manufacturer data, date of installation, vehicle traffic density, or air temperature parameters. In an example, the training data set 210 may comprise labeled baseline feature scores associated with the one or more operational data sets. The feature scores may be indicative of a metric associated with the maintenance cycle performed on an asset. For example, the metric may comprise a value (e.g., 0-10) indicative of a level of success associated with a maintenance cycle performed on the asset. The value may be compared to a threshold (e.g., 1-10) indicating whether the maintenance cycle was successful. For example, if the metric is above the threshold, it may be determined that the maintenance cycle was not successful. If the metric is below the threshold, it may be determined that the maintenance cycle was successful.

The automated machine learning module 230 may train the machine learning-based classifier 234 by extracting a feature set from the operational data (e.g., one or more operational data sets) in the transformed training data set 210/220 according to one or more feature selection techniques. In addition, the automated machine learning module 230 may select the machine learning model 232. For example, the automated machine learning module 230 may select the appropriate machine learning model 232 based on the specific maintenance cycle to be performed on the asset and evaluated to determine the metric indicative of the level of success associated with the maintenance cycle. Further, the automated machine learning module 230 may select the appropriate parameters 233 based on the maintenance cycle being evaluated. This enhances the automated machine learning module's 230 ability to appropriately tailor the trained classifier 234 to the specific maintenance cycle being evaluated and scored based on the trained classifier 234 (e.g., metric indicative the level of success of the maintenance cycle).

The automated machine learning module 230 may extract a feature set from the training data set 220 in a variety of ways. The automated machine learning module 230 may perform feature extraction multiple times, each time using a different feature-extraction technique. In an example, the feature sets generated using the different techniques may each be used to generate different machine learning-based classification models 234. In an example, the feature set with the highest quality metrics may be selected for use in training. The automated machine learning module 230 may use the feature set(s) to build one or more machine learning-based classification models 234A-234N that are configured to indicate whether or not new data is associated with an operational assessment of a transformer.

The training data set 220 may be analyzed to determine one or more features associated with one or more groups of operational parameters, wherein the one or more features may be further associated with one or more feature scores associated with a measure of success of a maintenance cycle of an asset (e.g., transformer). The one or more features and the one or more feature scores associated with the one or more groups of operational parameters may be considered as features (or variables) in the machine learning context. The term “feature,” as used herein, may refer to any characteristic of a group, or a series, of operational parameters that may be used to determine whether the group of operational parameters is associated with a feature score or a feature score range. By way of example, the features described herein may be associated with one or more groups of operational parameters.

A feature selection technique may comprise one or more feature selection rules. The one or more feature selection rules may comprise a parameter occurrence rule. The parameter occurrence rule may comprise determining which operational parameter, or group of operational parameters, in the training data set 220 occur over a threshold number of times and identifying those parameters that satisfy the threshold as candidate features. For example, any parameter, or group of parameters, that appear greater than or equal to 50 times in the training data set 220 may be considered as candidate features. Any parameter, or group of parameters, appearing less than 50 times may be excluded from consideration as a feature.

The one or more feature selection rules may comprise a significance rule. The significance rule may comprise determining, from the baseline feature level data in the training data set 220 (e.g., one or more operational data sets). The operational data sets may include data associated with an assessment, or analysis of one or one more of power parameters, voltage parameters, current parameters, capacity parameters, heat parameters, cooling tubes parameters, oil tank parameters, sunlight duration parameters, height of the transformer, date of manufacture, manufacturer data, date of installation, vehicle traffic density, or air temperature parameters. As the baseline feature level data in the training data set 220 are labeled according to one or more feature scores that are associated with one or more groups of operational parameters, the labels may be used to determine feature scores associated with a measure of success of a maintenance cycle performed on an asset based on one or more groups of operational parameters.

A single feature selection rule may be applied to select features or multiple feature selection rules may be applied to select features. In an example, the feature selection rules may be applied in a cascading fashion, with the feature selection rules being applied in a specific order and applied to the results of the previous rule. For example, the parameter occurrence rule may be applied to the training data set 220 to generate a first list of features. The significance rule may be applied to features in the first list of features to determine which features of the first list satisfy the significance rule in the training data set 220 and to generate a final list of candidate features.

The final list of candidate features may be analyzed according to additional feature selection techniques to determine one or more candidate feature signatures (e.g., groups, or series, of operational parameters that may be used to predict a metric indicative of a measure of success of a maintenance cycle performed on an asset). Any suitable computational technique may be used to identify the candidate feature signatures using any feature selection technique such as filter, wrapper, and/or embedded methods. In an example, one or more candidate feature signatures may be selected according to a filter method. Filter methods include, for example, Pearson's correlation, linear discriminant analysis, analysis of variance (ANOVA), chi-square, combinations thereof, and the like. The selection of features according to filter methods are independent of any machine learning algorithms. Instead, features may be selected on the basis of scores in various statistical tests for their correlation with the outcome variable (e.g., a feature score).

One or more candidate feature signatures may be selected according to a wrapper method. A wrapper method may be configured to use a subset of features and train a machine learning model using the subset of features. Based on the inferences that are drawn from a previous model, features may be added and/or deleted from the subset. Wrapper methods include, for example, forward feature selection, backward feature elimination, recursive feature elimination, combinations thereof, and the like. In an example, forward feature selection may be used to identify one or more candidate feature signatures. Forward feature selection is an iterative method that begins with no feature in the machine learning model. In each iteration, the feature which best improves the model is added until an addition of a new variable does not improve the performance of the machine learning model. In an example, backward elimination may be used to identify one or more candidate feature signatures. Backward elimination is an iterative method that begins with all features in the machine learning model. In each iteration, the least significant feature is removed until no improvement is observed on removal of features. In an example, recursive feature elimination may be used to identify one or more candidate feature signatures. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

In an example, one or more candidate feature signatures may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to absolute value of the magnitude of coefficients and ridge regression performs L2 regularization which adds a penalty equivalent to square of the magnitude of coefficients.

After the automated machine learning module 230 has generated a feature set(s) based on the feature selection 231, the model selection 232, and the parameter selection 233, the automated machine learning module 230 may generate a machine learning-based classification model 234 based on the feature set(s). Machine learning-based classification model, may refer to a complex mathematical model for data classification that is generated using machine-learning techniques. In one example, this machine learning-based classifier may include a map of support vectors that represent boundary features. By way of example, boundary features may be selected from, and/or represent the highest-ranked features in, a feature set.

In an example, the automated machine learning module 230 may use the feature sets extracted from the training data set 220 to build a machine learning-based classification model 234A-234N for one or more feature scores or one or more feature score ranges. In some examples, the machine learning-based classification models 234A-234N may be combined into a single machine learning-based classification model 234. Similarly, the machine learning-based classifier 234 may represent a single classifier containing a single or a plurality of machine learning-based classification models 234A-234N and/or multiple classifiers containing a single 234 or a plurality of machine learning-based classification models 234A-234N.

The extracted features (e.g., one or more candidate features and/or candidate features signatures derived from the final list of candidate features) may be combined in a classification model trained using a machine learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting machine learning-based classifier 234 may comprise a decision rule or a mapping that uses the expression levels of the features in the candidate feature signature to predict a score/metric indicative of a measure of success for a maintenance cycle performed on an asset based on operational data of the asset.

The candidate feature signature and the machine learning-based classifier 234 may be used to predict a score/metric indicative of a measure of success of a maintenance cycle in the testing data set. In one example, the result for each test includes a confidence level that corresponds to a likelihood or a probability that the corresponding test predicted a score/metric indicative of a measure of success of a maintenance cycle, or predicted at least a score/metric within a certain range. The confidence level may be a value between zero and one that represents a likelihood that the corresponding test is associated with a sore/metric indicative of a measure of success of a maintenance cycle. In one example, when there are two or more statuses (e.g., two or more operational assessments), the confidence level may correspond to a value p, which refers to a likelihood that a particular test is associated with a first status. In this case, the value 1-p may refer to a likelihood that the particular test is associated with a second status. In general, multiple confidence levels may be provided for each test and for each candidate feature signature when there are more than two statuses. A top performing candidate feature signature may be determined by comparing the result obtained for each test with known maintenance cycle metrics (e.g., operational parameters) for each test. In general, the top performing candidate feature signature will have results that closely match the known maintenance cycle metrics (e.g., operational parameters).

The top performing candidate feature signature may be used to predict a metric indicative of a measure of success of a maintenance cycle of an asset. For example, operational parameter data, comprising a plurality of operational parameters, for a potential asset may be determined/received. The operational parameter data for the potential asset may be provided to the machine learning-based classifier 234 which may, based on the top performing candidate feature signature, predict a metric indicative of a measure of success of a maintenance cycle. For example, the metric may comprise a value (e.g., 0-10) indicative of a level of success associated with a maintenance cycle. The value may be compared to a threshold (e.g., 1-10) indicating whether the maintenance cycle was successful. For example, if the metric is above the threshold, it may be determined that the maintenance cycle was not successful. If the metric is below the threshold, it may be determined that the maintenance cycle was successful.

FIG. 3 shows a flowchart of an example training method 300 for generating the machine learning-based classifier 234 using the automated machine learning module 230. The automated machine learning module 230 can implement supervised, unsupervised, and/or semi-supervised (e.g., reinforcement based) machine learning-based classification models 234A-234N. The method 300, as shown in FIG. 3, is an example of a supervised learning method; variations of this example of training method are discussed below, however, other training methods can be analogously implemented to train unsupervised and/or semi-supervised machine learning models.

The training method 300 may determine (e.g., access, receive, retrieve, etc.) operational data (e.g., one or more operational data sets) of one or more assets (e.g. transformers) at step 310. The operational data may contain one or more datasets, wherein each dataset may be associated with a time series of data. For example, the time series of data may be determined for a plurality of operational parameters of the asset, wherein the time series may comprise one or more time periods. An analysis may be performed for each time period of the data, wherein the data may be transformed, based on the analysis of each time period of the data, and provided as input data for determining/generating the predictive model. The analysis of each time period of data may involve various sources across multiple platforms for a single utility, although it is contemplated that some subject overlap may occur. The analysis may include studies pertaining to work order preventative/corrective maintenance, transformer oil dissolved gas analysis (DGA), tap controller oil DGA, inspection data, or equipment nameplate data across different time resolutions. In an example, the studies may include studies pertaining to historical data comprising historical sensor data derived from one or more sensors in communication with the components of the assets and/or historical field test data derived from one or more field tests performed on the components of the asset. As an example, each dataset may include a labeled list of predetermined features. As a further example, each dataset may comprise labeled feature scores associated with one or more groups of operational parameters of the asset. The feature scores may comprise a metric indicative of a measure of success of a maintenance cycle performed on the asset based on the studies, or the one or more groups of operational parameters.

The training method 300 may generate, at step 320, a training data set and a testing data set. The training data set and the testing data set may be generated by randomly assigning labeled feature data (e.g., labeled feature scores) associated with individual features (e.g., operational parameters) associated with the operational data to either the training data set or the testing data set. In some implementations, the assignment of the labeled feature data (e.g., labeled feature scores) associated with individual features (e.g., operational parameters) may not be completely random. In an example, only the labeled feature data (e.g., labeled feature scores) for a specific study may be used to generate the training data set and the testing data set. As an example, a majority of the labeled feature data (e.g., labeled feature scores) for the specific study may be used to generate the training data set. For example, 75% of the labeled feature data (e.g., labeled feature scores) for the specific study may be used to generate the training data set and 25% may be used to generate the testing data set. As a further example, only the labeled feature data (e.g., labeled feature scores) for the specific study may be used to generate the training data set and the testing data set.

The training method 300 may determine (e.g., extract, select, etc.), at step 330, one or more features that can be used by, for example, a classifier to differentiate among different groups of operational parameters to determine one or more feature scores, or one or more feature score ranges, associated with the one or more features. The one or more features may comprise a data set of set of the operational data associated with a group of operational parameters. As example, the training method 300 may determine a set of features from the operational data. As a further example, a set of features may be determined from operational data from a study different than the study associated with the labeled feature data (e.g., labeled feature scores) of the training data set and the testing data set. In other words, operational data from the different study (e.g., curated operational data sets) may be used for feature determination, rather than for training a machine learning model. In an example, the training data set may be used in conjunction with the operational data from the different study to determine the one or more features. The operational data from the different study may be used to determine an initial set of features, which may be further reduced using the training data set.

The training method 300 may train one or more machine learning models using the one or more features at step 340. As an example, the machine learning models may be trained using supervised learning. As a further example, other machine learning techniques may be employed, including unsupervised learning and semi-supervised learning. The machine learning models trained at step 340 may be selected based on different criteria depending on the problem to be solved and/or data available in the training data set. For example, machine learning classifiers can suffer from different degrees of bias. Accordingly, more than one machine learning model can be trained at step 340, optimized, improved, and cross-validated at step 350.

The training method 300 may select one or more machine learning models to build a predictive model at step 360 (e.g., a machine learning classifier). The predictive model may be evaluated using the testing data set. The predictive model may analyze the testing data set and generate classification values (e.g., feature scores) and/or predicted values (e.g., feature scores) at step 370. Classification and/or prediction values (e.g., feature scores) may be evaluated at step 380 to determine whether such values have achieved a desired accuracy level. Performance of the predictive model may be evaluated in a number of ways based on a number of true positive, false positive, true negative, and/or false negative classifications of the plurality of data points indicated by the predictive model. For example, the false positives of the predictive model may refer to a number of times the predictive model incorrectly classified/scored a group of operational parameters. Conversely, the false negatives of the predictive model may refer to a number of times the machine learning model determined that a classification value (e.g., feature score) was not associated with a group of operational parameters when, in fact, the group of operational parameters was associated with the classification value (e.g., feature score). True negatives and true positives may refer to a number of times the predictive model correctly classified/scored one or more groups of operational parameters. Related to these measurements are the concepts of recall and precision. Generally, recall refers to a ratio of true positives to a sum of true positives and false negatives, which quantifies a sensitivity of the predictive model. Similarly, precision refers to a ratio of true positives and a sum of true and false positives.

When such a desired accuracy level is reached, the training phase ends and the predictive model may be output at step 390; when the desired accuracy level is not reached, however, then a subsequent iteration of the training method 300 may be performed starting at step 310 with variations such as, for example, considering a larger collection of operational data.

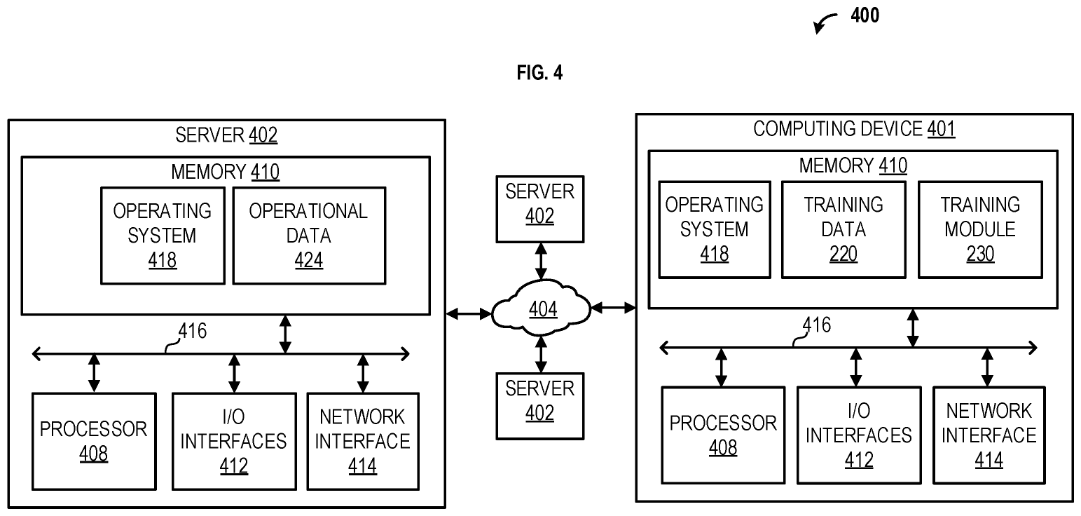

FIG. 4 shows a block diagram of an environment 400 comprising non-limiting examples of a computing device 401 and a server 402 connected through a network 404. In an aspect, some or all steps of any described method may be performed on a computing device as described herein. The computing device 401 can comprise one or multiple computers configured to store one or more of the training module 230, training data 220 (e.g., operational data 424), and the like. The server 402 can comprise one or multiple computers configured to store operational data 424 (e.g., curated parameter set data). Multiple servers 402 can communicate with the computing device 401 via the through the network 404.

The computing device 401 and the server 402 can be a digital computer that, in terms of hardware architecture, generally includes a processor 408, memory system 410, input/output (I/O) interfaces 412, and network interfaces 414. These components (408, 410, 412, and 414) are communicatively coupled via a local interface 416. The local interface 416 can be, for example, but not limited to, one or more buses or other wired or wireless connections, as is known in the art. The local interface 416 can have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 408 can be a hardware device for executing software, particularly that stored in memory system 410. The processor 408 can be any custom made or commercially available processor, a central processing unit (CPU), an auxiliary processor among several processors associated with the computing device 401 and the server 402, a semiconductor-based microprocessor (in the form of a microchip or chip set), or generally any device for executing software instructions. When the computing device 401 and/or the server 402 is in operation, the processor 408 can be configured to execute software stored within the memory system 410, to communicate data to and from the memory system 410, and to generally control operations of the computing device 401 and the server 402 pursuant to the software.

The I/O interfaces 412 can be used to receive user input from, and/or for providing system output to, one or more devices or components. User input can be provided via, for example, a keyboard and/or a mouse. System output can be provided via a display device and a printer (not shown). I/O interfaces 412 can include, for example, a serial port, a parallel port, a Small Computer System Interface (SCSI), an infrared (IR) interface, a radio frequency (RF) interface, and/or a universal serial bus (USB) interface.

The network interface 414 can be used to transmit and receive from the computing device 401 and/or the server 402 on the network 404. The network interface 414 may include, for example, a 10BaseT Ethernet Adaptor, a 100BaseT Ethernet Adaptor, a LAN PHY Ethernet Adaptor, a Token Ring Adaptor, a wireless network adapter (e.g., WiFi, cellular, satellite), or any other suitable network interface device. The network interface 414 may include address, control, and/or data connections to enable appropriate communications on the network 404.

The memory system 410 can include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory system 410 may incorporate electronic, magnetic, optical, and/or other types of storage media. Note that the memory system 410 can have a distributed architecture, where various components are situated remote from one another, but can be accessed by the processor 408.

The software in memory system 410 may include one or more software programs, each of which comprises an ordered listing of executable instructions for implementing logical functions. In the example of FIG. 4, the software in the memory system 410 of the computing device 401 can comprise the training module 230 (or subcomponents thereof), the training data 220, and a suitable operating system (O/S) 418. In the example of FIG. 4, the software in the memory system 410 of the server 402 can comprise, the training data 210, and a suitable operating system (O/S) 418. The operating system 418 essentially controls the execution of other computer programs and provides scheduling, input-output control, file and data management, memory management, and communication control and related services.

For purposes of illustration, application programs and other executable program components such as the operating system 418 are illustrated herein as discrete blocks, although it is recognized that such programs and components can reside at various times in different storage components of the computing device 401 and/or the server 402. An implementation of the training module 230 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

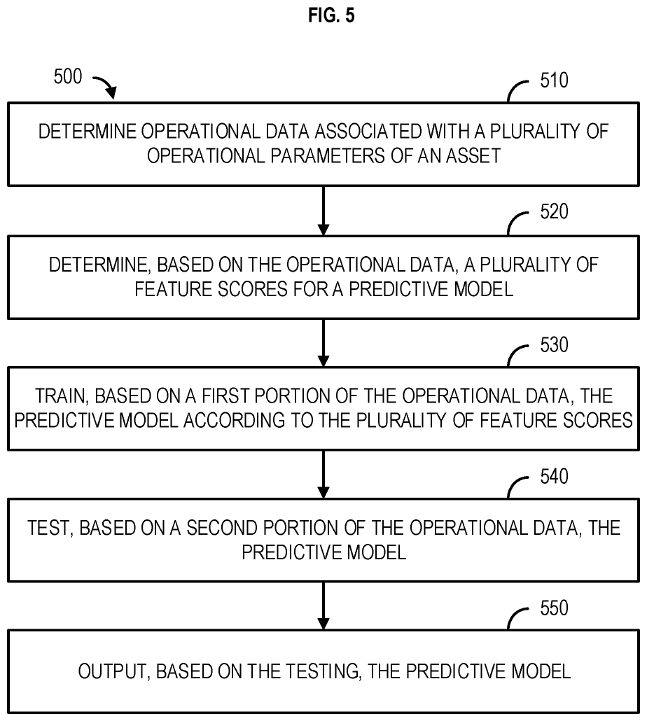

In an example, the training module 230 may be configured to perform a method 500, shown in FIG. 5. The method 500 may be performed in whole or in part by a single computing device, a plurality of electronic devices, and the like. The method 500 may comprise determining operational data associated with a plurality of operational parameters at 510. The operational data comprise one or more data sets based on the plurality of operational parameters of an asset (e.g., transformer). Each data set of the one or more data sets may comprise data indicative of a time series of data associated with the plurality of operational parameters of the asset, wherein the time series of data may comprise one or more time periods of data. The plurality of operational parameters may comprise one or more of a power parameter data set, a voltage parameter data set, a current parameter data set, a capacity parameter data set, a heat parameter data set, a cooling tubes parameter data set, an oil tank parameter data set, a sunlight duration parameter data set, a height of the transformer, a date of manufacture, manufacturer data, a date of installation, a vehicle traffic density, or an air temperature parameter data set. The plurality of operational parameters may comprise one or more groups of operational parameters. Each group of operational parameters of the plurality of operational parameters may be labeled according to a predefined feature score of a plurality of predefined features. The feature score may comprise a metric indicative of a measure of success of a maintenance cycle performed on the asset based on the one or more groups of operational parameters.

In one example, determining the operational data associated with the plurality of operational parameters may further comprise determining a time series of data associated with the plurality of operational parameters of the asset, wherein the time series comprises one or more time periods. An analysis for each time period of the data of the one or more time periods of data may be performed. The operational data may be generated based on the analysis of each time period of data, wherein the operational data comprises a data set associated with each time period. As a further example, determining the operational data associated the plurality of operational parameters may further comprise determining, based on the plurality of operational parameters, one or more operational data sets that comprises at least one operational parameter of the plurality of operational parameters. The operational data may be generated based on the one or more operational data sets. As a further example, determining the operational data associated with the plurality of operational parameters may further comprise determining baseline feature scores for each group of operational parameters of the plurality of operational parameters. The baseline feature scores for each group of operational parameters may then be labeled as a feature score associated with each group of operational parameters. The operational data may be generated based on the labeled baseline features for each group of operational parameters.

The method 500 may comprise determining, based on the operational data, a plurality of feature scores for a predictive model at step 520. In an example, determining, based on the operational data, the plurality of feature scores for the predictive model may comprise determining, from the operational data, feature scores associated with two or more operational data sets of a plurality of operational data sets as a first set of candidate feature scores, determining, from the operational data, feature scores associated with the first set of candidate feature scores that satisfy a first threshold score as a second set of candidate feature scores, and determining, from the operational data, feature scores of the second set of candidate feature scores that satisfy a second threshold score as a third set of candidate feature scores, wherein the plurality of feature scores comprises the third set of candidate feature scores.

The method 500 may comprise training, based on a first portion of the operational parameters data, the predictive model according to the plurality of feature scores at step 530. Training, based on a first portion of the operational parameters data, the predictive model according to the plurality of feature scores results in determining a feature signature indicative of the feature score associated with each group of operational parameters.

The method 500 may comprise testing, based on a second portion of the operational data, the predictive model at step 540. The method 500 may comprise outputting, based on the testing, the predictive model at 550. The predictive model may be configured to output a prediction indicative of a measure, or level, of success of a maintenance cycle performed on the asset. For example, the predictive model may be configured to output a prediction score associated with the maintenance cycle performed on the asset. For example, the prediction score may comprise a value (e.g., 1-10) indicative of the measure/level of success of the maintenance cycle. The prediction score may be compared with a threshold value/score (e.g., 1-10) to determine whether the maintenance cycle was successful. If the prediction score is above the threshold, it may be determined that the maintenance cycle was not successful. If the prediction score is below the threshold, it may be determined that the maintenance cycle was successful.

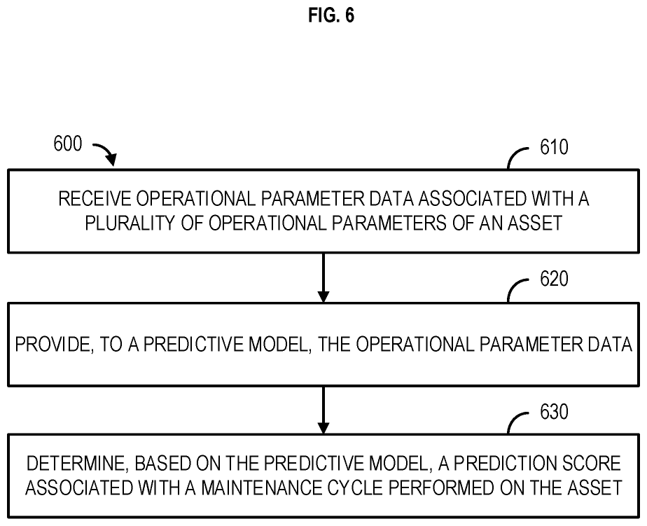

In an example, the training module 230 may be configured to perform a method 600, shown in FIG. 6. The method 600 may be performed in whole or in part by a single computing device, a plurality of electronic devices, and the like. The method 600 may comprise receiving operational parameter data associated with a plurality of operational parameters of an asset (e.g., transformer) at step 610. The plurality of operational parameters may be determined during the operation of the asset. The plurality of operational parameters may comprise one or more of power parameters, voltage parameters, current parameters, capacity parameters, heat parameters, cooling tubes parameters, oil tank parameters, sunlight duration parameters, height of the transformer, date of manufacture, manufacturer data, date of installation, vehicle traffic density, or air temperature parameters. The method 600 may comprise providing, to a predictive model, the operational parameter data at step 620. The method 600 may comprise determining, based on the predictive model, a prediction score associated with a maintenance cycle performed on the asset at step 630. The prediction score may comprise a metric indicative of measure of success of a maintenance cycle performed on the asset. For example, the metric may comprise a value (e.g., 1-10) indicative of the measure/level of success of the maintenance cycle. The prediction score may be compared with a threshold value/score (e.g., 1-10) to determine whether the maintenance cycle was successful. If the prediction score is above the threshold, it may be determined that the maintenance cycle was not successful. If the prediction score is below the threshold, it may be determined that the maintenance cycle was successful.

Training the predictive model may comprise determining operational data associated with the plurality of operational parameters of the asset, wherein the plurality of operational parameters include one or more groups of operational parameters, wherein each group of the operational parameters of the plurality of operational parameters is labeled according to a feature score, determining, based on the operational data, a plurality of feature scores for the predictive model, training, based on a first portion of the operational data, the predictive model according to the plurality of feature scores, testing, based on a second portion of the operational data, the predictive model, and outputting, based on the testing, the predictive model.

The operational data may comprise one or more data sets, wherein each data set of the one or more data sets comprise data indicative of a time series of data associated with the asset.

Determining the operational data associated with the plurality of operational parameters may further comprise determining a time series of data associated with the asset, wherein the time series comprises one or more time periods. An analysis for each time period of the data of the one or more time periods of data may be performed. The operational data may be generated based on the analysis of each time period of data. As a further example, determining the operational data associated the plurality of operational parameters may further comprise determining, based on the plurality of operational parameters, one or more operational data sets that comprise at least one operational parameter of the plurality of operational parameters. As a further example, determining the operational data associated with the plurality of operational parameters may further comprise determining baseline feature scores for each group of operational parameters associated with the plurality of operational parameters. The baseline feature scores for each group of operational parameters may then be labeled as feature scores associated with each group of operational parameters.

Determining, based on the operational data, the plurality of feature scores for the predictive model may comprise determining, from the operational data, feature scores associated with two or more operational parameter data sets of a plurality of different operational parameter data sets as a first set of candidate feature scores, determining, from the operational data, feature scores of the first set of candidate feature scores that satisfy a first threshold score as a second set of candidate feature scores, and determining, from the operational data, feature scores of the second set of candidate feature scores that satisfy a second threshold score as a third set of candidate feature scores, wherein the plurality of feature scores comprises the third set of candidate feature scores.

Training, based on the first portion of the operational data, the predictive model according to the plurality of feature scores results in determining a feature signature indicative of a feature score associated with each group of operational parameters.

Embodiment 1: A method comprising: determining operational data associated with a plurality of operational parameters associated with an asset, wherein the plurality of operational parameters comprise one or more groups of operational parameters, and wherein each group of operational parameters of the one or more groups of operational parameters is labeled according to a feature score, determining, based on the operational data, a plurality of feature scores for a predictive model, training, based on a first portion of the operational data, the predictive model according to the plurality of feature scores, testing, based on a second portion of the operational data, the predictive model, and outputting, based on the testing, the predictive model.

Embodiment 2: The embodiment as in any one of the preceding embodiments wherein the operational data comprises one or more data sets, wherein each data set of the one or more data sets comprises data indicative of a time series of data associated with the asset.

Embodiment 3: The embodiment as in any one of the preceding embodiments, wherein the plurality of operational parameters comprise one or more of power parameters, voltage parameters, current parameters, capacity parameters, heat parameters, cooling tubes parameters, oil tank parameters, sunlight duration parameters, height of the transformer, date of manufacture, manufacturer data, date of installation, vehicle traffic density, or air temperature parameters.

Embodiment 4: The embodiment as in any one of the preceding embodiments, wherein the asset comprises a transfer.

Embodiment 5: The embodiment as in any one of the preceding embodiments wherein determining the operational data associated with the plurality of operational parameters comprises retrieving the operational data from a public data source.

Embodiment 6: The embodiment as in any one of the preceding embodiments wherein determining the operational data associated with the plurality of operational parameters comprises: determining a time series of data associated with the plurality of operational parameters associated with the asset, wherein the time series comprises one or more time periods, performing an analysis for each time period of the data of the one or more time periods of the data, and generating, based on the analysis of each time period of the data, the operational data, wherein the operational data comprises a data set associated with each time period.

Embodiment 7: The embodiment as in any one of the preceding embodiments wherein determining the operational data associated with the plurality of operational parameters comprises: determining, based on the plurality of operational parameters, one or more operational data sets associated with at least one operational parameter of the plurality of operational parameters, and generating, based on the one or more operational data sets, the operational data.

Embodiment 8: The embodiment as in any one of the preceding embodiments wherein determining the operational data associated with the plurality of operational parameters comprises: determining baseline feature scores for each group of operational parameters of the plurality of operational parameters, labeling the baseline feature scores for each group of operational parameters of the plurality of operational parameters as the feature score associated with each group of operational parameters, and generating, based on the labeled baseline feature scores, the operational data.

Embodiment 9: The embodiment as in any one of the preceding embodiments wherein determining, based on the operational data, the plurality of feature scores for the predictive model comprises: determining, from the operational data, feature scores associated with two or more operational data sets of a plurality of operational data sets as a first set of candidate feature scores, determining, from the operational data, feature scores associated with the first set of candidate feature scores that satisfy a first threshold score as a second set of candidate feature scores, and determining, from the operational data, feature scores associated with the second set of candidate feature scores that satisfy a second threshold score as a third set of candidate feature scores, wherein the plurality of feature scores comprises the third set of candidate feature scores.

Embodiment 10: The embodiment as in any one of the preceding embodiments wherein the feature score comprises a metric indicative of a measure of success of a maintenance cycle performed on the asset based on the one or more groups of operational parameters.

Embodiment 11: The embodiment as in any one of the preceding embodiments wherein training, based on the first portion of the operational data, the predictive model according to the plurality of feature scores results in determining a feature signature indicative of the feature score associated with each group of operational parameters.

Embodiment 12: The embodiment as in any one of the preceding embodiments wherein the predictive model is configured to output a prediction indicative of a measure of success of a maintenance cycle performed on the asset.

Embodiment 13: The embodiment as in any one of the preceding embodiments wherein the predictive model is configured to output a prediction score associated with a maintenance cycle performed on the asset.

Embodiment 14: The embodiment as in the embodiment 13, further comprising determining, based on the prediction score satisfying a threshold, a prediction indicative of the maintenance cycle being successful.

Embodiment 15: The embodiment as in the embodiment 13, further comprising determining, based on the prediction score satisfying a threshold, a prediction indicative of the maintenance cycle being unsuccessful.

Embodiment 16: A method comprising: receiving operational parameter data comprising a plurality of operational parameters of an asset, wherein the plurality of operational parameters are determined during an analysis of one or more operations performed by the asset, providing, to a predictive model, the operational parameter data, and determining, based on the predictive model, a prediction score associated with a maintenance cycle performed on the asset.

Embodiment 17: The embodiment as in the embodiment 16, wherein the plurality of operational parameters comprises one or more of power parameters, voltage parameters, current parameters, capacity parameters, heat parameters, cooling tubes parameters, oil tank parameters, sunlight duration parameters, height of the transformer, date of manufacture, manufacturer data, date of installation, vehicle traffic density, or air temperature parameters.

Embodiment 18: The embodiment as in any one of the embodiments 16-17, wherein the asset comprises a transformer.

Embodiment 19: The embodiment as in any one of the embodiments 16-18, further comprising training the predictive model.

Embodiment 20: The embodiment as in any one of the embodiments 16-19, wherein training the predictive model comprises: determining operational data associated with the plurality of operational parameters of the asset, wherein the plurality of operational parameters comprise one or more groups of operational parameters, wherein each group of operational parameters of the one or more groups of operational parameters is labeled according to a feature score, determining, based on the operational data, a plurality of feature scores for the predictive model, training, based on a first portion of the operational data, the predictive model according to the plurality of feature scores, testing, based on a second portion of the operational data, the predictive model, and outputting, based on the testing, the predictive model.

Embodiment 21: The embodiment as in the embodiment 20 wherein the operational data comprises one or more data sets, wherein each data set of the one or more data sets comprise data indicative of a time series of data associated with the asset.

Embodiment 22: The embodiment as in the embodiments 20-21 wherein determining the operational data associated with the plurality of operational parameters comprises retrieving the operational data from a public data source.

Embodiment 23: The embodiment as in the embodiments 20-22 wherein determining the operational data associated with the plurality of operational parameters comprises: determining a time series of data associated with the plurality of operational parameters associated with the asset, wherein the time series comprises one or more time periods, performing an analysis for each time period of the data of the one or more time periods of the data, and generating, based on the analysis of each time period of the data, the operational data, wherein the operational data a data set associated with each time period.

Embodiment 24: The embodiment as in the embodiments 20-23 wherein determining the operational data associated with the plurality of operational parameters comprises: determining, based on the plurality of operational parameters, one or more operational data sets associated with at least one operational parameter of the plurality of operational parameters, and generating, based on the one or more operational data sets, the operational data.

Embodiment 25: The embodiment as in the embodiments 20-24 wherein determining the operational data associated with the plurality of operational parameters comprises: determining baseline feature scores for each group of operational parameters of the plurality of operational parameters, labeling the baseline feature scores for each group of operational parameters of the plurality of operational parameters as the feature score associated with each group of operational parameters, and generating, based on the labeled baseline feature scores, the operational data.

Embodiment 26: The embodiment as in the embodiments 20-25 wherein determining, based on the operational data, the plurality of feature scores for the predictive model comprises: determining, from the operational data, feature scores associated with two or more operational parameter data sets of a plurality of parameter data sets as a first set of candidate feature scores, determining, from the operational data, feature scores of the first set of candidate feature scores that satisfy a first threshold score as a second set of candidate feature scores, and determining, from the operational data, feature scores of the second set of candidate feature scores that satisfy a second threshold score as a third set of candidate feature scores, wherein the plurality of feature scores comprises the third set of candidate scores.

Embodiment 27: The embodiment as in the embodiments 20-26 wherein the feature score comprises a metric indicative of a measure of success of a maintenance cycle performed on the asset based on the one or more groups of operational parameters.

Embodiment 28: The embodiment as in the embodiments 20-27 wherein training, based on the first portion of the operational data, the predictive model according to the plurality of feature scores results in determining a feature signature indicative of the feature score associated with each group of operational parameters.

Embodiment 29: The embodiment as in the embodiments 16-28 further comprising determining, based on the prediction score satisfying a threshold, a prediction indicative of the maintenance cycle being successful.

Embodiment 30: The embodiment as in the embodiments 16-28 further comprising determining, based on the prediction score satisfying a threshold, a prediction indicative of the maintenance cycle being unsuccessful.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
determining, by a computing device, operational data associated with a plurality of operational parameters associated with an asset, wherein the plurality of operational parameters comprise one or more groups of operational parameters, and wherein each group of operational parameters of the one or more groups of operational parameters is labeled according to a feature score;
determining, based on the operational data, a plurality of feature scores for a predictive model;
training, based on a first portion of the operational data, the predictive model according to the plurality of feature scores;
testing, based on a second portion of the operational data, the predictive model; and
outputting, based on the testing, the predictive model.

2. The method of claim 1, wherein the operational data comprises one or more data sets, wherein each data set of the one or more data sets comprises data indicative of a time series of data associated with the plurality of operational parameters associated with the asset.

3. The method of claim 1, The method of claim 1, wherein the plurality of operational parameters comprises one or more of power parameters, voltage parameters, current parameters, capacity parameters, heat parameters, cooling tubes parameters, oil tank parameters, sunlight duration parameters, height of the transformer, date of manufacture, manufacturer data, date of installation, vehicle traffic density, or air temperature parameters.

4. The method of claim 1, wherein the asset comprises a transformer.

5. The method of claim 1, wherein determining the operational data associated with the plurality of operational parameters comprises:
determining a time series of data associated with the plurality of operational parameters associated with the asset, wherein the time series comprises one or more time periods;
performing an analysis for each time period of the data of the one or more time periods of the data; and
generating, based on the analysis of each time period of the data, the operational data, wherein the operational data comprises a data set associated with each time period.

6. The method of claim 1, wherein determining the operational data associated with the plurality of operational parameters comprises:
determining baseline feature scores for each group of operational parameters of the plurality of operational parameters;
labeling the baseline feature scores for each group of operational parameters of the plurality of operational parameters as the feature score associated with each group of operational parameters; and
generating, based on the labeled baseline feature scores, the operational data.

7. The method of claim 1, wherein determining, based on the operational data, the plurality of feature scores for the predictive model comprises:
determining, from the operational data, feature scores associated with two or more operational data sets of a plurality of operational data sets as a first set of candidate feature scores;
determining, from the operational data, feature scores associated with the first set of candidate feature scores that satisfy a first threshold score as a second set of candidate feature scores; and
determining, from the operational data, feature scores associated with the second set of candidate feature scores that satisfy a second threshold score as a third set of candidate feature scores,
wherein the plurality of feature scores comprises the third set of candidate feature scores.

8. The method of claim 1, wherein the predictive model is configured to output a prediction score indicative of a measure of success of a maintenance cycle performed on the asset.

9. The method of claim 8, further comprising determining, based on the prediction score satisfying a threshold, a prediction indicative of the maintenance cycle being successful.

10. The method of claim 8, further comprising determining, based on the prediction score satisfying a threshold, a prediction indicative of the maintenance cycle being unsuccessful.

11. A method comprising:
receiving, at a computing device, operational parameter data comprising a plurality of operational parameters of an asset, wherein the plurality of operational parameters are determined during an analysis of one or more operations performed by the asset;
providing, to a predictive model, the operational parameter data; and
determining, based on the predictive model, a prediction score associated with a maintenance cycle performed on the asset.

12. The method of claim 11, wherein the plurality of operational parameters comprises one or more of power parameters, voltage parameters, current parameters, capacity parameters, heat parameters, cooling tubes parameters, oil tank parameters, sunlight duration parameters, height of the transformer, date of manufacture, manufacturer data, date of installation, vehicle traffic density, or air temperature parameters.

13. The method of claim 11, wherein the asset comprises a transformer.

14. The method of claim 11, further comprising training the predictive model.

15. The method of claim 14, wherein training the predictive model comprises:
determining operational data associated with the plurality of operational parameters of the asset, wherein the plurality of operational parameters comprise one or more groups of operational parameters, and wherein each group of operational parameters of the one or more groups of operational parameters is labeled according to a feature score;
determining, based on the operational data, a plurality of feature scores for the predictive model;
training, based on a first portion of the operational data, the predictive model according to the plurality of feature scores;
testing, based on a second portion of the operational data, the predictive model; and
outputting, based on the testing, the predictive model.

16. The method of claim 15, wherein determining the operational data associated with the plurality of operational parameters comprises:
determining a time series of data associated with the plurality of operational parameters associated with the asset, wherein the time series comprises one or more time periods;
performing an analysis for each time period of the data of the one or more time periods of the data; and
generating, based on the analysis of each time period of the data, the operational data, wherein the operational data comprises a data set associated with each time period.

17. The method of claim 15, wherein determining the operational data associated with the plurality of operational parameters comprises:
determining baseline feature scores for each group of operational parameters of the plurality of operational parameters;
labeling the baseline feature scores for each group of operational parameters of the plurality of operational parameters as the feature score associated with each group of operational parameters; and
generating, based on the labeled baseline feature scores, the operational data.

18. The method of claim 15, wherein determining, based on the operational data, the plurality of feature scores for the predictive model comprises:
determining, from the operational data, feature scores associated with two or more operational data sets of a plurality of operational data sets as a first set of candidate feature scores;
determining, from the operational data, feature scores associated with the first set of candidate feature scores that satisfy a first threshold score as a second set of candidate feature scores; and
determining, from the operational data, feature scores associated with the second set of candidate feature scores that satisfy a second threshold value as a third set of candidate feature scores,
wherein the plurality of feature scores comprises the third set of candidate feature scores.

19. The method of claim 11, further comprising determining, based on the prediction score satisfying a threshold, a prediction indicative of the maintenance cycle being successful.

20. The method of claim 11, further comprising determining, based on the prediction score satisfying a threshold, a prediction indicative of the maintenance cycle being unsuccessful.
